(19) United States
(12) Patent Application Publication
(10) Pub. No.: US 2019/0340272 A1
(43) Pub. Date: Nov. 7, 2019

(54) SYSTEMS AND RELATED METHODS FOR UPDATING ATTRIBUTES OF NODES AND LINKS IN A HIERARCHICAL DATA STRUCTURE

(71) Applicant: doTERRA Holdings, LLC, Pleasant Grove, UT (US)

(72) Inventors: David Breiter, Orem, UT (US); Lawrence Cardon, Springville, UT (US)

(21) Appl. No.: 15/969,454

(22) Filed: May 2, 2018

(51) Int. Cl. G06F 17/30

(52) U.S. Cl. CPC G06F 17/30336; G06F 17/30327

(57) ABSTRACT

Various embodiments described in this disclosure relate to techniques and related systems for database management, and some embodiments relate more specifically to techniques for processing hierarchical data structures having nodes with dependent-attributes using relationship objects, updating such dependent node attributes, and reporting engines that use databases that use such data structures.

### TECHNICAL FIELD

Various embodiments described in this disclosure relate to techniques and related systems for database management, and some embodiments relate more specifically to techniques for processing hierarchical data structures having nodes with dependent-attributes using relationship objects.

### BACKGROUND

In a hierarchical data structure, nodes represent records in a database and links (also called “edges”) indicate hierarchical relationships among the records. The parent-child organization of the records resembles a tree-structure. Nodes may correspond to a row-in-a-row orientated relational database or a column in a columnar oriented relational database.

Hierarchical databases may be incorporated into or support application servers that perform large numbers of transactions. The databases may store extremely large datasets that involve millions of nodes. In some cases, database management processes may be performed on many, if not all, of the nodes with each transaction processed by an application server.

There are drawbacks and deficiencies with existing database management processing systems and techniques.

### BRIEF SUMMARY

Various embodiments of the disclosure relate, generally, to method of updating a node object of a tree-structure. The method may include updating at least one attribute of the node object responsive to an attribute associated with a sub-tree of the tree-structure and one or more attribute rules. The tree-structure may include the node object, at least one child-node object to the node object, and at least one relationship object defining a parent-child relationship among the node object and the at least one child-node object. The at least one relationship object may include at least some attributes of the sub-tree of the tree-structure.

Other embodiments of the disclosure related to a system. The system may include a database store and a computer system. The database store may have a databased stored thereon. The database may include records and relationship records that define one or more hierarchical relationships among the records. The computer system may be operative to be executed as a database engine system responsive to requests received relative to the database. The database engine system may include a record update module and a relationship record update module. The record update module may be configured to determine one or more updates to a record of the database responsive to changes to one or more records of the database. The one or more records may be below the updated record in the hierarchy of the database. The relationship record update module may be configured to determine one or more updates to a relationship record that are indicative of the changes to the one or more records of the database.

### BRIEF DESCRIPTION OF THE DRAWINGS

Purposes and advantages of the embodiments of the disclosure will be apparent to one of ordinary skill in the art from the detailed description in conjunction with the appended drawings, including:

FIG. 1 illustrates a tree-structure, in accordance with an embodiment of the disclosure.

FIG. 2 illustrates records of a database, in accordance with an embodiment of the disclosure.

FIG. 3 illustrates relationship records of a database, in accordance with an embodiment of the disclosure.

FIG. 4 illustrates a dependent structure of links and node in a tree-structure, in accordance with an embodiment of the disclosure.

FIG. 5 illustrates an operating environment, in accordance with an embodiment of the disclosure.

FIG. 6A illustrates an architecture of a database server system, in accordance with an embodiment of the disclosure.

FIG. 6B, illustrates a runtime environment, in accordance with an embodiment of the disclosure.

FIG. 7 illustrates a database engine, in accordance with an embodiment of the disclosure.

FIG. 8 illustrates a process flow diagram of a runtime environment, in accordance with an embodiment of the disclosure.

FIG. 9 illustrates an update operation for a lowest level of node objects in a tree-structure, in accordance with an embodiment of the disclosure.

FIG. 10 illustrates an update operation for a level of node objects in a tree-structure where at least node object does not correspond to the lowest level of the tree-structure, in accordance with an embodiment of the disclosure.

FIG. 11 illustrates an update operation for a root-node object in a tree-structure, in accordance with an embodiment of the disclosure.

FIG. 12 illustrates a process flow diagram of a runtime environment processing a reporting operation, according to an embodiment of the disclosure.

FIG. 13 illustrates a reporting operation performed by a runtime engine and a database reporting for a node object in a tree-structure, according to an embodiment of the disclosure.

### DETAILED DESCRIPTION

The following description provides specific details to provide a thorough description of various embodiments of the invention. However, one of ordinary skill in the art will understand that the disclosed embodiments may be practiced without using these specific details. Indeed, the disclosed embodiments may be practiced in conjunction with conventional systems and methods used in the industry. In addition, only those elements helpful to understand and enable one of ordinary skill in the art to practice the disclosed embodiments are described in detail. One of ordinary skill in the art will recognize that some elements not described herein but, using various conventional method components and acts, would be in accord with the embodiments of this disclosure.

The following description may include examples to help enable one of ordinary skill in the art to practice the disclosed embodiments. The use of the terms “exemplary,” “by example,” and “for example,” means that the related description is explanatory and though the scope of the disclosure is intended to encompass the recited examples and legal equivalents, the use of such terms is not intended to limit the scope of an embodiment or this disclosure to the specified components, steps, features, functions, arrangement of components, or the like. Moreover, the use of such terms does not indicate or imply that the related description comprises or is a preferred embodiment.

Any drawings accompanying this disclosure are for illustrative purposes only and are not drawn to scale. Elements common among figures may retain the same numerical designation; however, the similarity in numbering does not mean that the structures or components are necessarily identical in size, composition, configuration, or any other property.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are by way of example only and should not be construed as the only way to implement the present disclosure unless specified otherwise herein. Additionally, block definitions and partitioning of logic between various blocks is/are examples of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Many of the functional units described in this specification may be illustrated, described or labeled as logic, modules, engines, threads, or other segregations of programming code, to more particularly emphasize their implementation independence in accomplishing the features, functions, tasks or steps that are generally described herein. The various illustrative logical blocks, modules, and circuits described in connection with the embodiments disclosed herein may be at least partially implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

These logic and modules may also be implemented using software or firmware, stored on a computer-readable storage medium, in system memory, or a combination thereof for execution by various types of processors.

In the case of a general-purpose computer, these logic and modules may be embodied in software classes and applications executed by processor cores, and while the modules are executing the general-purpose computer may be a special purpose computer or a specific purpose computer. The logic and modules may also relate to specific purpose hardware, including the firmware and machine code, controlling its operation. An identified module of executable code may, for instance, comprise one or more physical or logical blocks of computer instructions, which may, for instance, be organized as a thread, object, procedure, or function. Nevertheless, the executable code of an identified module need not be physically located together, but may comprise disparate instructions stored in different locations that, when joined logically together, comprise the module and achieve the stated purpose for the module.

A module of executable code may comprise a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the software portions are stored on one or more physical devices, which are referred to herein as computer-readable media.

In some embodiments, the software portions are stored in a non-transitory state such that the software portions or representations thereof, persist in the same physical location for a period of time. Additionally, in some embodiments, the software portions are stored on one or more non-transitory storage mediums, which include hardware elements capable of storing non-transitory states and/or signals representative of the software portions, even though other portions of the non-transitory storage mediums may be capable of altering and/or transmitting the signals. Examples of non-transitory storage mediums are Flash memory and random-access memory (RAM). Another example of a non-transitory storage medium includes a read-only memory (ROM) which can store signals and/or states representative of the software portions for a period of time. However, the ability to store the signals and/or states is not diminished by further functionality of transmitting signals that are the same as, or representative of, the stored signals and/or states. For example, a processor may access the ROM to obtain signals that are representative of the stored signals and/or states to execute the corresponding software instructions.

A general purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor may be considered a “special-purpose computer” when the general-purpose computer is configured to execute computing instructions (e.g., software code) related to embodiments of the present disclosure.

The embodiments disclosed herein may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Various embodiments described herein may include elements described as implemented in a “workstation,” “computer,” or a “computer system.” Here, the terms “workstation,” “computer,” and “computer system” are to be understood to include at least one non-transitory computer-readable storage medium and at least one processor. In general, the storage medium will store, at one time or another, at least portions of an executable program code, and the processor(s) will execute one or more of the instructions included in that executable program code. It will be appreciated that the terms “executable program code” and “software” mean substantially the same thing for the purposes of this description. It is not necessary to the practice of the various embodiments described herein that the storage medium and the processing unit be physically located in the same place. That is to say, it is foreseen that the processor and the memory might be distributed among physical pieces of equipment or even in geographically distinct locations. One of ordinary skill in the art will appreciate that “computer-readable memory,” “media,” “medium,” “storage medium,” “computer-readable media,” or “computer-readable medium” as used here, may include a diskette, a magnetic tape, a digital tape, a compact disc, an integrated circuit, a ROM, a CD, DVD, Blu-Ray, a cartridge, Flash memory, PROM, a RAM, a memory stick or card, or any other non-destructive storage medium useable by computers, including those that are re-writable.

Although the enabling software might be “written on” a disc, “embodied in” an integrated circuit, “carried over” a communications circuit, “stored in” a memory chip, or “loaded in” a cache memory, it will be appreciated that, for the purposes of this disclosure, the software will be referred to simply as being “in” or “on” a main memory that is a computer-readable medium. Thus, the terms “in” or “on” are intended to encompass the above mentioned and all equivalent and possible ways in which software can be associated with a computer-readable medium.

Users may interact with the computer systems described herein by way of graphical user interfaces (GUIs) on a display and input devices such as touchscreens, keyboards, a computer mouse, touchpads, buttons, switches, jumpers, and the like. A GUI may include a console and/or dashboard and a user may interact with the GUI and, in turn, underlying software applications.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes, to a degree, that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, “tree-structure” means a non-linear, linked, data structure that is composed of at least one node. If the tree-structure has more than one node, then the tree-structure may include one or more links, directed or un-directed, that indicate a relationship between two nodes. If no direction is specified, the direction is assumed to be parent-child with a downward direction indicating that relationship. A “subtree” of a tree-structure T means a tree-structure consisting of a node in the tree-structure T and all of the node descendants in the tree-structure T. Accordingly, the subtree corresponding to the root node is the entire tree-structure T, and each node is the root node of the subtree it determines. The “level” of a node means the number of relationships between the node and the root node of the tree-structure, with the root node understood to be at level 0.

As used herein, “attribute” means a field or a table in a database. A node of a tree-structure may have one or more attributes, for example, a node may correspond to a record and have the attribute of that record as well as comprise one or more data fields, each an attribute.

As used herein, “dependent attribute” means an attribute that is a function of at least one other attribute, node, characteristic of a tree structure, or arrangement of nodes relative to each other. The other attributes may be referred to herein as “parameter attributes.” The parameter attributes may be associated with a different node than the dependent attributes; however, they may be attributes of the same node. Further, a dependent attribute and a parameter attribute may have an ancestor-descendant hierarchical relationship; however, their relationship may be descendant-ancestor or siblings.

Generally, the techniques used to update a tree-structure are at least partially dictated by the data and the rules that govern the data. For example, one conventional updating technique is to start at the top of the tree-structure at the “root” node, search the tree-structure until the target node is found, and update the node attributes with new values, and then repeat for the next node, and the next node, etc., in a linear fashion. Various algorithms and tools (e.g., an index) are sometimes used to, for example, shorten the search path (i.e., the number of nodes searched) or the number of comparisons performed in absolute terms.

Conventional techniques used to search, resolve, and report on one or more aspects of a tree-structure have similar disadvantages and are similarly limited.

It is now understood that such conventional techniques for searching, reporting on, and updating a tree-structure are inefficient—e.g., in terms of time, computational intensity, etc., for example, if a value of a field in a node is a dependent attribute.

By way of example, per conventional techniques, each node in a tree-structure may updated independently, without taking into account what has already been performed. There may be considerable overlap in computation from one node to the next, as each node is updated. Tree-structures that dependent attributes at multiple levels may require a high computational intensity to update the tree-structure compared to a tree-structure that does not.

Various embodiments described herein relate to processes that incorporate level-by-level parallel processing of nodes, and/or partial computations at one or more levels in a tree-structure. A partial computation may be indicative of the contribution of parameter attributes to a dependent attribute (e.g., the value) as determined by rules for determining attributes. For example, a process may update a dependent attribute responsive to, among other things, one or more partial computations, where the partial computations summarize some part of the values or information in the tree-structure below the node of the dependent attribute. In some embodiments, the process may start with the nodes in the lowest level of a tree-structure and then propagate partial computations through each level of a tree-structure.

Various embodiments described herein also relate to incorporating relationship objects into a tree structure, where a relationship object defines one or more relationships between a node and other nodes, and include data (including partial computations) relevant to updating dependent attributes of nodes as well as reporting about the node or tree-structure.

In various embodiments, node objects may be based on node records, and those records may include information relevant to relationships of a node for multiple tree-structures.

One advantage of embodiments of the present disclosure, for example, is that a process may search and update each dependent attribute fewer times than a process executing per conventional techniques that update a dependent attribute each time a parameter attribute is updated. Another advantage of such an embodiment, is that groups of nodes may be processed in parallel. Yet another advantage of such an embodiment, is that the total number of actions a process executes to update a tree-structure may be drastically reduced relative to a process executing per conventional techniques. Finally, dependent attributes may be updated in substantially real-time as updates propagate up a tree-structure, which facilitates fast availability of information for reporting.

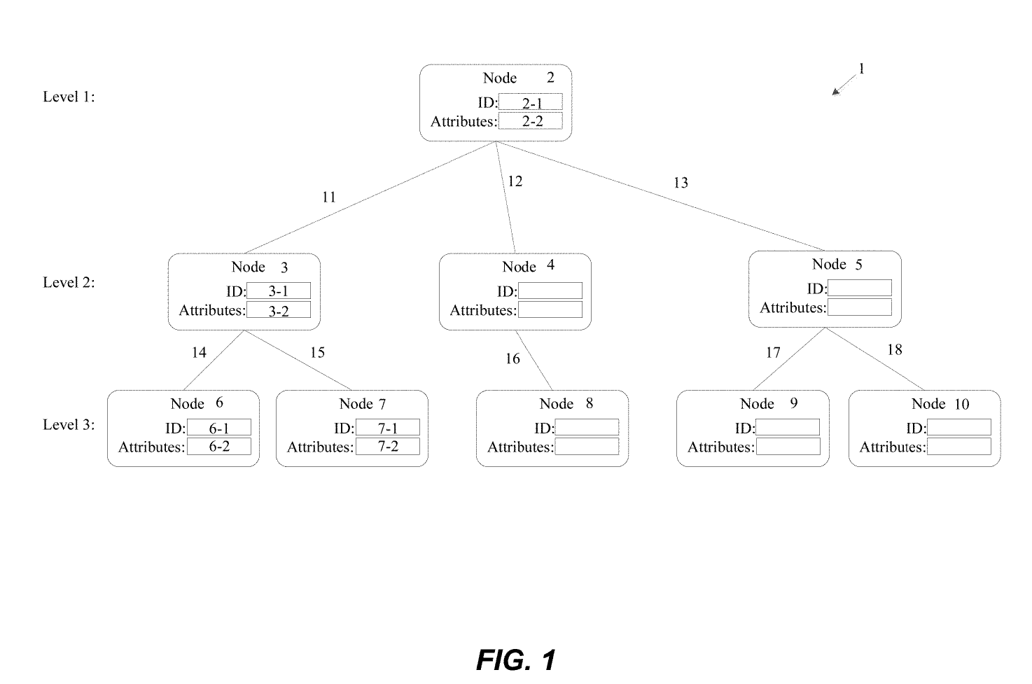

FIG. 1 illustrates a tree-structure 1 according to an embodiment of the disclosure. The tree-structure 1 may include a root node 2, and one or more nodes 3, 4, 5, 6, 7, 8, 9, and 10 that are descendants of root node 2. Each node may include an identifier (ID) and one or more attributes. For example, root node 2 includes ID 2-1 and attributes 2-2, node 3 includes ID 3-1 and attributes 3-2, node 6 includes ID 6-1 and attributes 6-2, and node 7 includes ID 7-1 and attributes 7-2, and so on.

The tree-structure 1 may also include various links that define relationships between nodes, including links 11, 12, 13, 14, 15, 16, 17 and 18. For example, link 11 defines a relationship between node 2 and node 3, link 12 defines a relationship between node 2 and node 4, link 13 defines a relationship between node 2 and node 5, link 14 defines a relationship between node 3 and node 6, and so on. Notably, node 3 is a child of root node 2, and nodes 6 and 7 are each a child of node 3 and a descendant of root node 2.

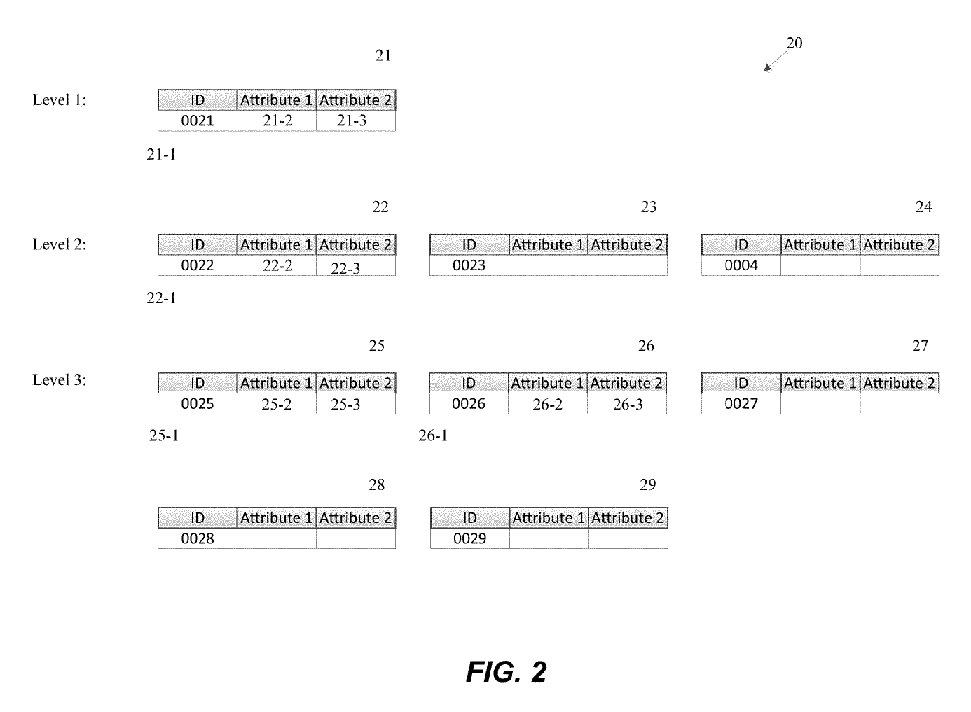

In various embodiments, the tree-structure 1 may illustrate the hierarchical relationship of the nodes 2 through 10 stored in a database 20 (FIG. 2) at runtime. Each node and each link may be objects of an instance of one or more node-type classes and link-type classes. Each node-type class may include at least a form of an “ID” variable and “attributes” variable(s).

FIG. 2 illustrates records of a database 20 according to an embodiment of the disclosure. The database 20 may be stored on one or more computer-readable memory. The database 20 may include node records 21, 22, 23, 24, 25, 26, 27, 28, and 29. The node records 21-28 are shown at levels 1, 2, and 3, which correspond to levels 1, 2, and 3 of the tree-structure 1 and node objects 2 to 10 at runtime. For example, the object of node 2 includes at least some of the data/values of record 21, the object of node 3 includes at least some of the data/values of node record 22, the object of node 6 includes at least some of the data/values of node record 25, the object of node 7 includes at least some of the data/values of node record 26, and so on.

The node records 21, 22, 25 and 26 correspond to the nodes 2, 3, 6 and 7, respectively. Further, node IDs 2-1, 3-1, 6-1 and 7-1 correspond to record IDs 21-1, 22-1, 25-1 and 26-1, respectively; and node attributes 2-2, 3-2, 6-2 and 7-2 correspond to record attributes 21-2/21-3, 22-2/22-3, 25-2/25-3, and 26-2/26-3, respectively. Although two attributes are shown for each record corresponding to each node, any number of attributes are contemplated. Optionally, records of the database 20 may include pointers to memory addresses of related records, IDs of related records, or other means to identify the relationships.

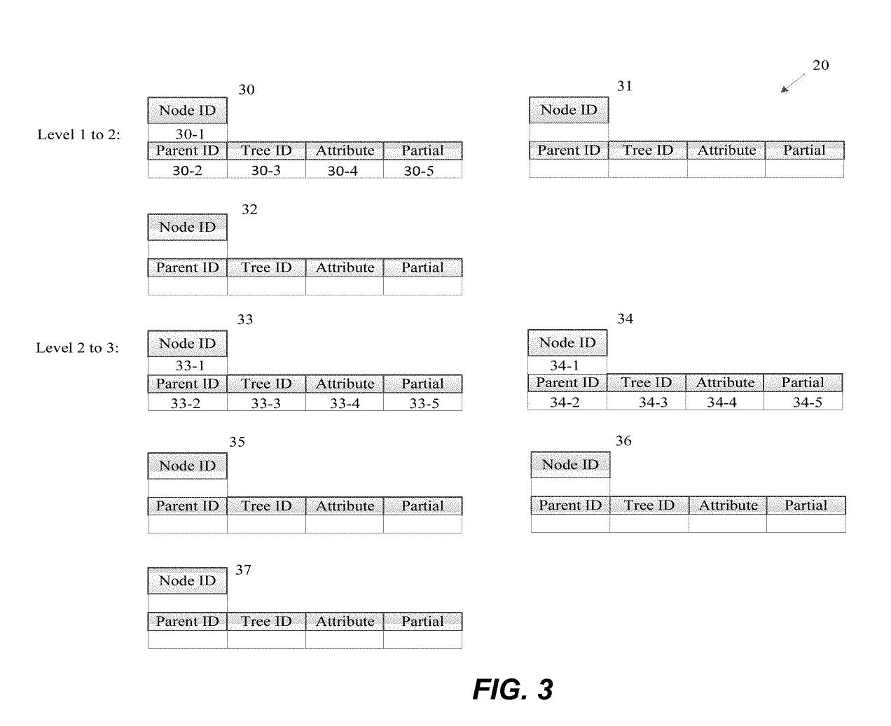

As illustrated in FIG. 3, the database 20 may include one or more relationship records 30, 31, 32, 33, 34, 35, 36, and 37, according to an embodiment of the disclosure. The relationship records 30 to 37 may include fields for data that is indicative of one or more hierarchical relationships among the records 21 to 29. In particular, the relationship records 30 to 37 correspond to the links 11 to 18 (see FIG. 1), respectively.

Each record includes a node ID, a parent ID, a tree ID, attributes, and partial computations. A node ID associates a relationship record with a node record of the database 20. For example, Node ID 30-1 may store the ID “0022” for node record 22 (see FIG. 2). The relationship record 30 defines one or more relationships between the node records identified by the node ID 30-1 and parent nodes identified by the parent ID 30-2. For example, Parent ID 30-2 may store the ID “0021” for record 21. The tree ID 30-3 identifies a specific tree structure associated with the parent-child relationship. For example, the parent-child relationship between node records 21 and 22 is associated with tree-structure 1, and so an ID for tree-structure 1 may be stored in tree ID 30-3. Similarly, the attributes 30-4 and partial computations 30-5 may be associated with the parent-child relationship and/or the tree structure in tree ID 30-3.

While the embodiments described herein refer to the tree-structure 1, the node records and relationship records of database 20 may be associated with multiple tree structures. For example, a database of employee records may be associated with an organizational tree structure, a reporting tree structure, a compensation tree structure, etc.; a database of sales agent records may be associated with a first bonus tree-structure, a second bonus tree structure, and so on. Thus, relationship record 30 may include additional fields to define additional parent IDs 30-2, tree IDs 30-3, attributes 30-4, and partial computations 30-5.

For ease of illustration, the records 21 to 29 and relationship records 30 to 37 are shown as tables and the fields are arranged in rows. The embodiments of the present disclosure are not limited to row-oriented relational database or database management systems that read and write data in rows. For example, the database 20 may be a column-oriented relational database (e.g., a columnar database). Further, the embodiments of the present disclosure may be incorporated into, or used with, database management systems the read and write data in columns.

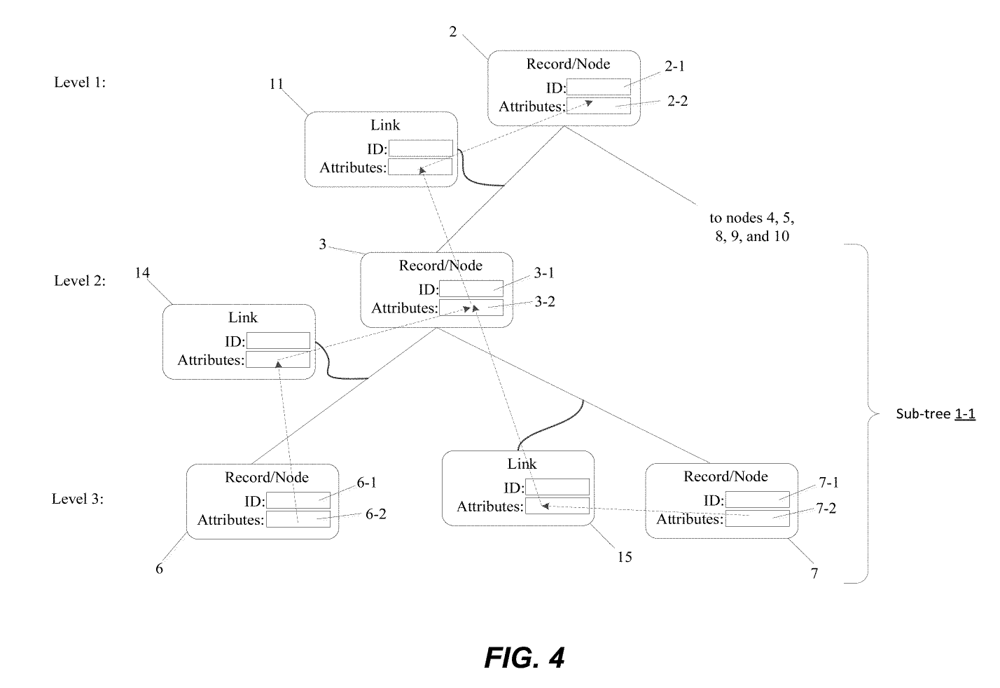

In one embodiment, the attributes fields of the relationship record illustrated in FIG. 3 may include data indicative of attributes descendant nodes, characteristics of sub-trees, or arrangements of various nodes in a tree structure. For example, attributes 30-3 may include data that is indicative of one or more attributes of the subtree 1-1 (FIG. 4) comprising nodes 3, 6 and 7 of tree-structure 1. Examples of attributes of the sub-tree include number of qualifying nodes and/or sub-trees, number of non-qualifying nodes and/or sub-trees, “yes or no” there are qualifying nodes and/or sub-trees, sizes of qualifying sub-trees and non-qualifying sub-trees, and combinations thereof. The number and variations of attributes and rules to determine an attribute are design characteristics of a system.

FIG. 4 illustrates a dependent structure of the nodes 2, 3, 6 and 7, according to an embodiment of the disclosure. Attributes 2-2 and attributes 3-2 are dependent attributes. Attributes 3-2, 6-2 and 7-2 are parameter attributes. Note that attributes 3-2 are dependent attributes because they depend on the attributes 6-2 and 7-2, as well as parameter attributes because attributes 2-2 depend on the value of attributes 2-3. Attributes 2-2 may depend also on one or more attributes of nodes 4, 5, 8, 9 and 10, which are omitted from FIG. 4 for ease of illustration. In various embodiments, dependent attributes may depend directly on the value of parameter attributes, a characteristic of a parameter attribute, a characteristic of sub-tree, a quality of a parameter attribute, a quality of a sub-tree, or combinations thereof—collectively referred to herein as “dependency parameters.” In some embodiments, metrics may be used to quantify qualities or characteristics of an attribute, subtree or combinations thereof

In various embodiments, relationship objects 11, 14, and 15 may define the hierarchical relationship among nodes 2, 3, 6 and 7. The relationship objects 11, 14 and 15 include attributes 11-2, 14-2, and 15-2, respectively, which may be used to update one or more of dependent attributes 2-2 and 3-2. In some embodiments, the attributes 11-2, 14-2 and 15-2 may be indicative of parameter attributes, for example, parameter attributes 3-2, 6-2, and 7-2. Further, the attributes 11-2, 14-2, and 15-2 may be indicative of a contribution by parameter attributes 3-2, 6-2 and 7-2 to dependent attribute 2-2, that is, a partial computation. Similarly, the attributes 14-2 and 15-2 may be indicative of a contribution by parameter attributes 6-2 and 7-2 to dependent attribute 3-2. In some embodiments, the attributes 11-2, 14-2 and 15-2 may include partial computations of values that may be the value ultimately stored in a dependent attribute. Not all attributes of nodes in a sub-tree are necessarily used to update a dependent attribute or the attribute of a link node. In one embodiment, only qualifying attributes are used to update the dependent attribute and/or the attribute of a link node. For example, only attributes having a value above a threshold or coming from a qualifying node might be used.

By way of example, the attribute 2-2 may include the sum of the attributes 3-2, 6-2, and 7-2. Weighting parameters may be incorporated into the calculation of attributes 2-2. By way of another example, attributes 2-2 may be determined responsive to a number of qualifying nodes in the subtree 1-1. The values of attributes 3-2, 6-2, and 7-2 may be compared to a threshold to determine if the respective node is “qualifying” Accordingly, the calculation of attributes 2-2 may be based on the number of descendant nodes of node 2, the number qualifying descendant nodes of node 2, the height of node 2, and the like. One of ordinary skill in the art will recognize that the embodiments described herein are not limited to any specific algorithm, factors, or parameters for defining dependent attributes.

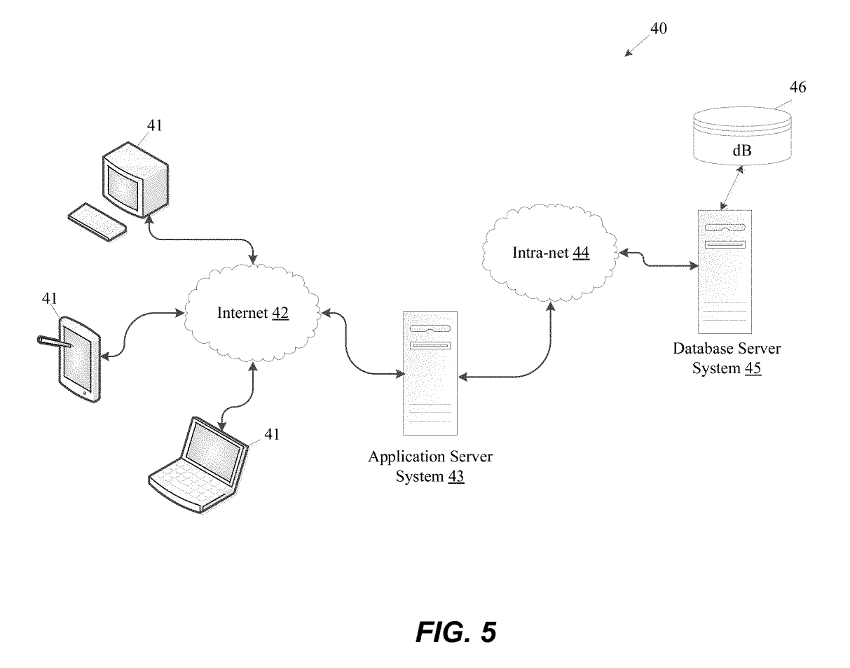

FIG. 5 illustrates an operating environment 40, according to an embodiment of the disclosure. One or more database server systems 45 host, directly or indirectly, a database 46. Access requests are received through some combination of an Internet 42 and Intra-net 44 from an application server system 43 that includes one or more application servers. In one embodiment, the application servers may be engaged in online transaction processing (OLTP) and other operations that require high-performance to support complex queries of the database 46, and engage in both read and write access to the database 46. Examples of OLTP include data warehousing, data mining, data and/or analytics reporting, business process management, and combinations thereof.

The specific operations of the application server system 43 may be directed by, or execute in support of, client applications executed on terminals 41. The terminals 41 may be, for example, personal computers, work stations, laptops, tablets, smart phones, servers, and combinations thereof. The client applications executing on the terminals 41 may be applications, as well as browsers used to access services hosted remotely, including at the application server system 43.

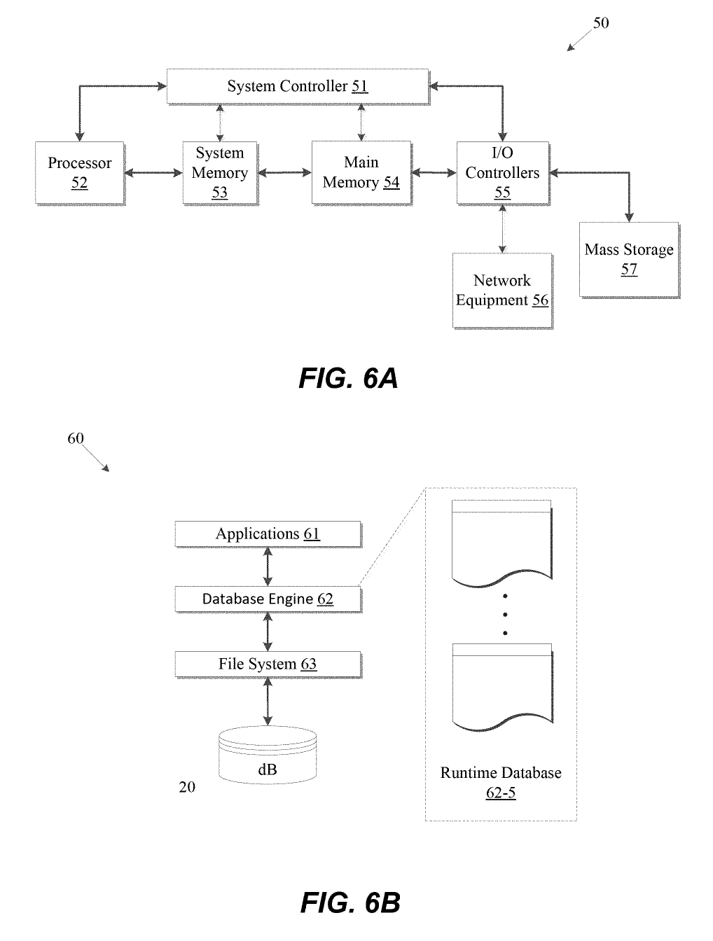

FIG. 6A illustrates an architecture 50 of a database server system 45, according to an embodiment of the disclosure. A processor 52 is coupled to system memory 53 (e.g., on core and/or off core cache), which is coupled to a main memory 54. In some embodiments, main memory 54 may be substantially larger than system memory 53. A system controller 51 may be configured to control data transfers between the processor 52, system memory 53, and main memory 54 subsystems. The system controller 51 may also be configured to control data transfers to various subsystems through one or more input/output (I/O) controllers 55 that connect, directly or indirectly, to one or more of mass storage 57 and network equipment 56. Other I/O devices may be coupled to the I/O controllers 55, for example, display devices, input devices, etc. In one embodiment, a database 20 may be physically stored on the mass storage 57. The I/O controllers 55 may couple, directly or indirectly, to the database 20, and the system controller 51 may be configured to control data transfer to and from the database 20 via the I/O controllers 55, and to and from the various subsystems of the architecture 50.

FIG. 6B, illustrates a runtime environment 60, according to embodiments of the disclosure. In various embodiments, database read and update requests are received from one or more executing applications 61 and satisfied via a database engine 62 that provides access to a runtime database 62-5 containing one or more node and relationship objects of a tree-structure. The applications 61 may be executed local or remote with respect to the database engine 62. A database 20 may be implemented in a computer-readable storage medium coupled directly to the database server system 45 (e.g., the mass storage 57) or remotely through a storage area network (SAN) or other distributed data storage system. At runtime, a file system 63 may interface with the database 20 and the database engine 62.

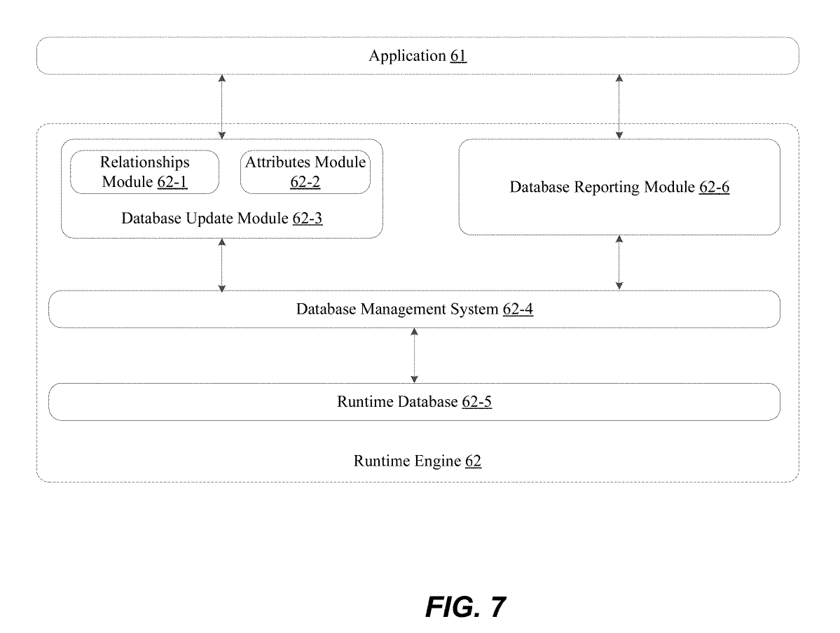

FIG. 7 illustrates a database engine 70 according to an embodiment of the disclosure. The various embodiments of the database engine 70 may be incorporated into a runtime environment 60. A database management system (DBMS) 62-4 may include one or more executing applications configured to receive and execute responsive to requests structured (e.g., a query) to create, retrieve update and manage data in a database 20. At runtime, the DBMS 62-4 may interact with, or incorporate, a runtime database 62-5 that is created responsive to the database 20. The DBMS 62-4 may be, for example, MySQL®, MongoDB®, Microsoft SQL SERVER®, ORACLE®, SYBASE®, or IBM DB2®; other in-memory column-oriented relational database management systems; and the like.

The DBMS 62-4 may be configured to receive one or more structured requests, directly or indirectly, from the database update module (DBUM) 62-3 and a database reporting module (DBRM) 62-6. The DBUM 62-3 may be configured to insert and update records stored in the database 20, for example, via requests to the DBMS 62-4. The DBRM 62-6 may be configured to query the database 20 based on one or more criteria and generate reports about the database 20.

In various embodiments, the DBUM 62-3 may include a relationships module 62-1, and an attributes module 62-2. The attributes module 62-2 may be configured to receive data, process the data, and request update that the database 20 responsive to the data. The update module 62-2 may include a rules engine that may define, among other things, processes for updating the database 20 responsive to specific events and data received from the application 61. By way of an example based on a sales processing system, the database update module 62-3 may receive a payment confirmation event that includes data about the amount of one or more payments. The attributes module 62-2 may include rules for processing the payment amount and determining and updating one or more attributes of a node responsive to the type of even, amount and/or other event data.

In one or more embodiments, the attributes module 62-2 may also include a rules engine that defines one or more processes for updating dependent attributes responsive to one or more dependency parameters. In some embodiments, the rules engine 62-6 may determine attributes responsive to partial computations.

In various embodiments, the relationships module 62-1 may be configured to receive data, process the data, and store attributes and partial computations in relationship records in the database 20, responsive to the data. The relationships module 62-1 may include a rules engine that defines one or more processes for calculating partial computations and determining dependency parameters of dependent attributes, as well as inserting, reading and updating relationship record 30.

In various embodiments, the relationship module 62-1 and attributes module 62-2 may be configured to store values in the records and relationship records of the database 20 by way of the DBMS 62-4.

In one embodiment, the DBRM 62-6 includes rules defining one or more processes for generating and providing reporting data about a node, a tree structure, or a sub-tree structure, responsive to one or more requests received from the application 61. The DBRM 62-6 may generate reports responsive to relationship objects and node objects. Regarding relationship objects, the DBRM 62-6 may generate reports responsive to dependency parameters, as well as other attributes related to a tree-structure, sub-tree structure, or node that are not dependency parameters but are a relevant parameter for a specific reporting process.

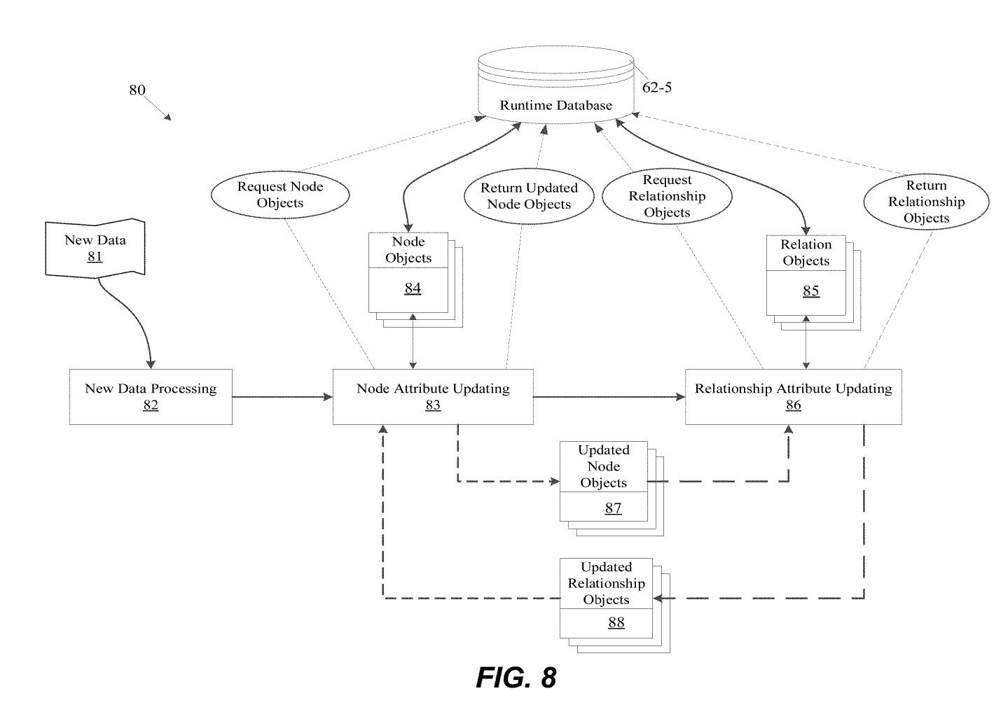

FIG. 8 illustrates a process flow diagram of a runtime environment 60 (FIG. 6) processing a data update operation 80, according to an embodiment of the disclosure. New data processing 82 receives and processes new data 81. Processing may include, for example, parsing an electronic transaction file to extract data relevant to updating the database 20.

Node attribute updating 83 receives the processed new data 81 and one or more node objects 84 are requested responsive to the processed new data 81. For example, if an electronic transaction record was related to a particular record in database 20 then node attribute updating 83 may request the relevant record by sending a request comprising information indicative of the record, such as an ID.

Multiple records in the database 20 may need to be updated responsive to the processed new data 81 and various rules. In some embodiments, a structured request such as a SQL SET operation may be used by the runtime database 62-5 to retrieve multiple records (including all of the records) corresponding to nodes at the same level in the tree-structure 1. Such operations may be particularly effective if a characteristic of a tree structure is that nodes at the same level in such tree-structure do not have a dependent/parameter relationships—in other words, changes to a node at a certain level do not affect other nodes at the same level.

Node attribute updating 83 may update one or more of the node objects 84 responsive to the processed new data 81 as well as processes defined at the attributes module 62-2. If the node objects 84 have child nodes in the tree-structure 1, then the node objects 84 may also be updated responsive to one or more relationship objects 88, including partial computations. Updated node objects 87 may be provided to the runtime database 62-5 and corresponding records of the database 20 may be updated responsive to the node objects 84. The relationship attribute updating 86 may receive one or more updated node objects 87, and may request and receive one or more relationship objects 85 from the runtime database 62-5. In some embodiments, a structured request such as a SQL SET operation may be used by the runtime database 62-5 to retrieve multiple relationship records from the database 20. The relationship objects 85 may be updated responsive to the values in the one or more node objects 84 as well as processes defined by the relationship rules engine 62-7.

The updated relationship objects 88 may be provided to the runtime database 62-5 and corresponding relationship records in the database 20 may be updated responsive to the updated relationship objects 88. If there are one or more records for parent nodes in the tree-structure 1 to be updated, then the updated relationship objects 88 may be provided to node attribute updating 83, and the next level of node objects 84 may be requested and updated responsive to the updated relationship objects 88 and/or the processed new data 81.

In one embodiment, each change to a node record or relationship record may be stored with a time stamp. A node record, node object, relationship record, or relationship object or even the database 20 or tree-structure 1 may be reconstructed for a given moment in time or time period responsive to the stored changes and time stamps.

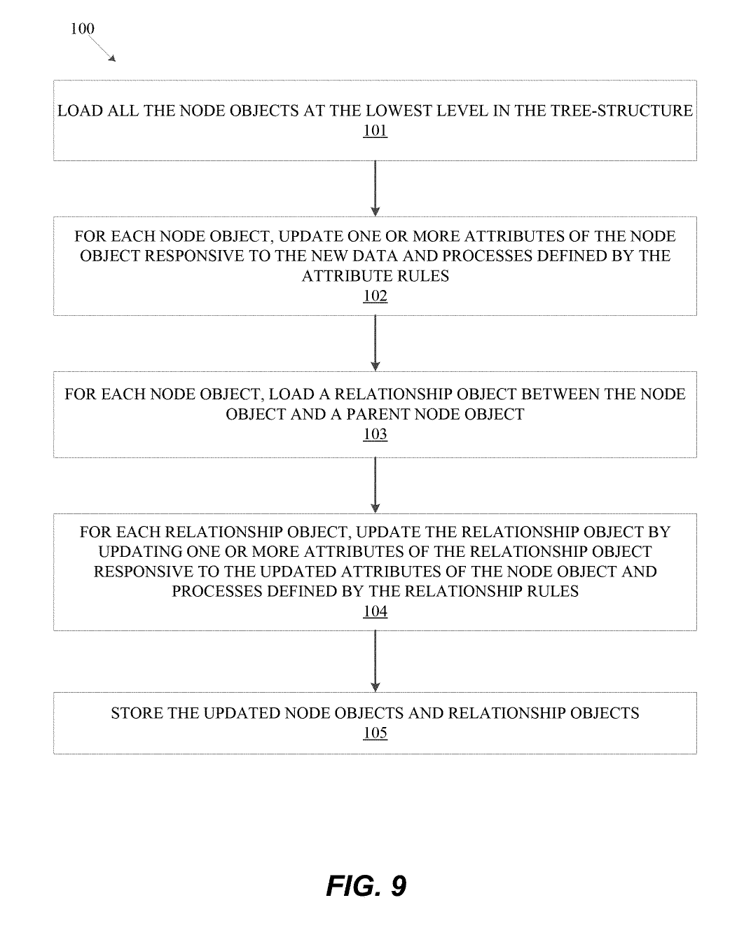

FIG. 9 illustrates an update operation 100 performed by the runtime engine 62 and the database update module 62-3 for the lowest level of node objects in a tree-structure 1. All of the nodes at the lowest level in the tree-structure 1 are requested and loaded in operation 101. Notably, all such nodes will be end-nodes of tree-structure 1. By way of example, for tree-structure 1 that is nodes 6, 7, 8, 9 and 10. In one embodiment, all of the node objects at that level are requested. For each node object, one or more attributes of the node object are updated responsive to new data and processes defined by the attribute rules engine 62-6, in operation 102. In one embodiment, all of the node objects are updated in parallel.

For each node object, each relationship object is loaded that defines a link from the node object to its parent node object in operation 103. Each relationship object is updated by updating one or more attributes of the relationship object responsive to the updated attributes of the end-node and the processes defined by the relationship rules engine 62-7, in operation 104. In one embodiment, the updated attributes of the relationship object may be parameter attributes, including without limitation partial computations. In one embodiment, all of the relationship objects are updated in parallel. Data from each updated node object and updated relationship object is stored in corresponding records in database 20, in operation 105.

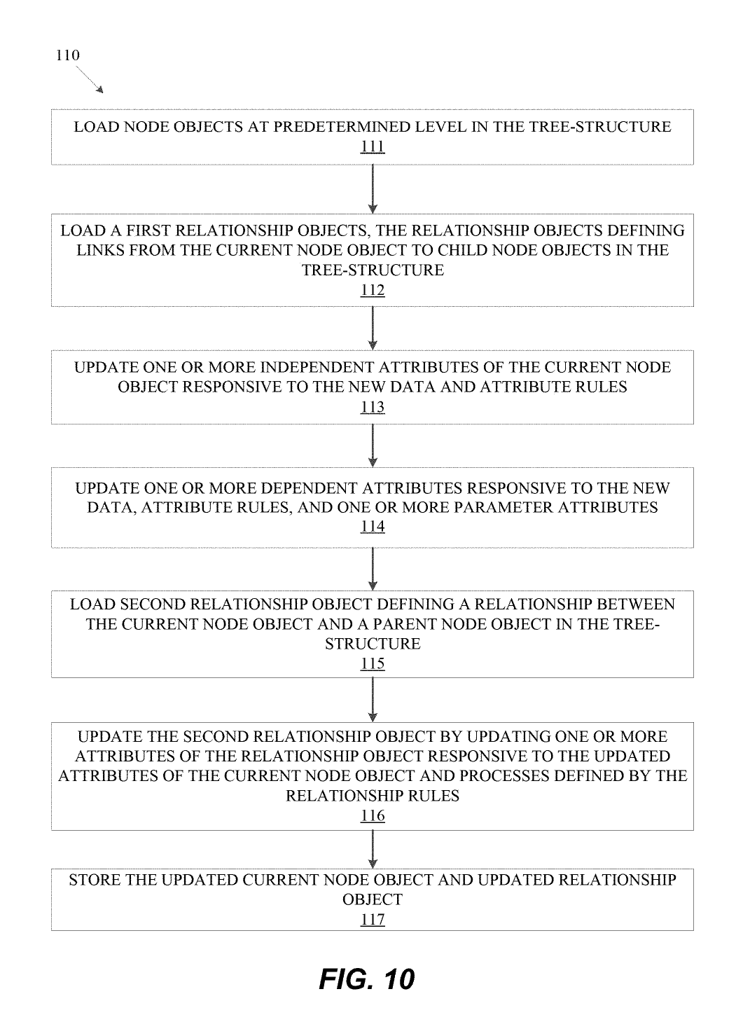

FIG. 10 illustrates an update operation performed by the runtime engine 62 and the database update module 62-3 for a level of node objects in a tree-structure 1 that does not correspond to the lowest level of the tree-structure 1. In tree-structure 1 that is nodes 3, 4, and 5. All of the node objects at a predetermined level in the tree-structure 1 are loaded in operation 111. For each node object at the predetermined level, the relationship objects from the current node object to each child node object in the tree-structure 1 are loaded in operation 112. In one embodiment, the relationship objects may already be loaded, for example, because they were loaded while updating node objects at a lower level of tree-structure 1.

For each node object, one or more independent attributes of the current node object are updated responsive to one or more of the new data and the processes defined by the attribute rules engine 62-6, in operation 113. For each node object, one or more dependent attributes are updated responsive to the new data, the processes defined by the attribute rules engine 62-6, and one or more parameter attributes of the relationship objects, in operation 114. The parameter attributes may include one or more partial computations. In one embodiment, at least one attribute of the relationship object is a partial computation. In one embodiment, all of the node objects are updated in parallel.

For each node object, the relationship object from the current node object to its parent node object in the tree-structure is loaded in operation 115. Each relationship object is updated by updating one or more attributes of the relationship object responsive to the updated attributes of the current node object and the processes defined by the relationship rules engine 62-7, operation 116. In one embodiment, the updated attributes of the relationship object may be parameter attributes, including without limitation partial computations. In one embodiment, all of the relationship objects are updated in parallel. The updated current node objects and updated relationship objects are stored in corresponding records and relationship records of database 20 in operation 117.

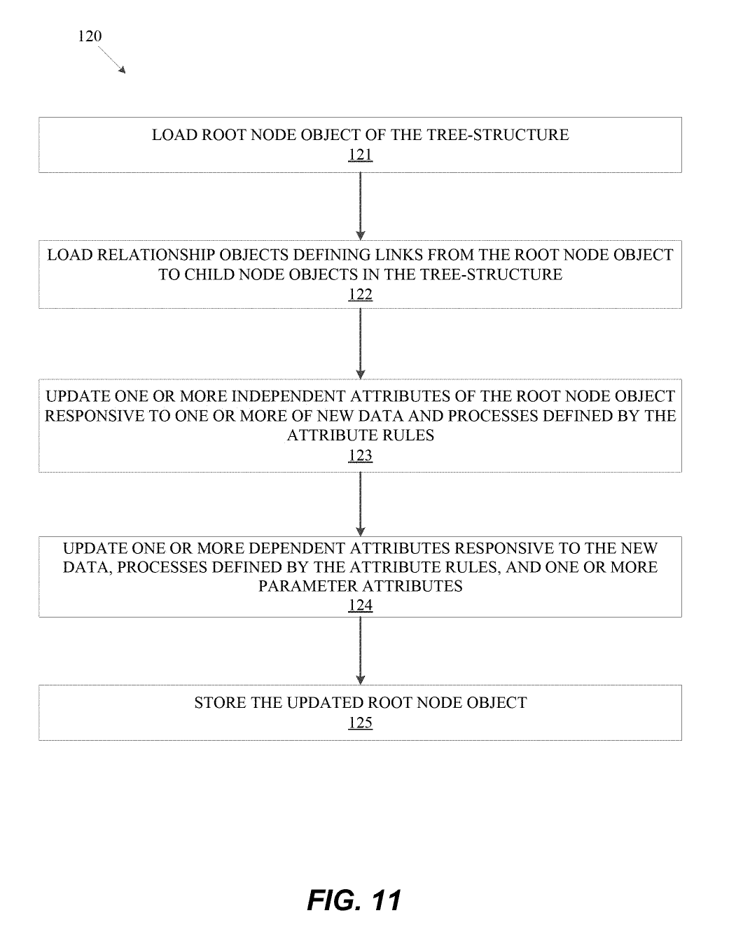

FIG. 11 illustrates an update operation performed by the runtime engine 62 and the database update module 62-3 for the root-node object of the tree-structure 1. Notably, In tree-structure 1 that is node 2 (see FIG. 1). The root-node object of the tree-structure 1 is requested and loaded in operation 121. The relationship objects for the links from the root-node object to each child node object of the root-node object in the tree-structure are requested and loaded in operation 122. In one embodiment, the relationship objects may already be loaded, for example, because they were loaded while updating node objects at a lower level of the tree. One or more independent attributes of the root-node object are updated responsive to one or more of new data and the processes defined by the attribute rules engine 62-6, in operation 123. One or more dependent attributes of the root-node are updated responsive to one or more of new data, one or more parameter attributes of the relationship objects, and the processes defined by the attribute rules engine 62-6, in operation 124. The parameter attributes may include one or more partial computations. The updated root-node is stored in a corresponding record of database 20 in operation 125.

In another embodiment, information about a sub-tree may be retrieved from the relationship object immediately above the sub-root node of the sub-tree. This facilitates more efficient reporting than if the sub-tree had to be processed to gather requested information, for example, to generate and provide requested reporting.

While the embodiments have been described with reference to whole objects and values being updated, one of ordinary skill in the art will recognize that the embodiments are not so limited. For example, differentials indicative of the difference between a record and relationship records before and after updating may be used to update the records and relationship records of the database 20.

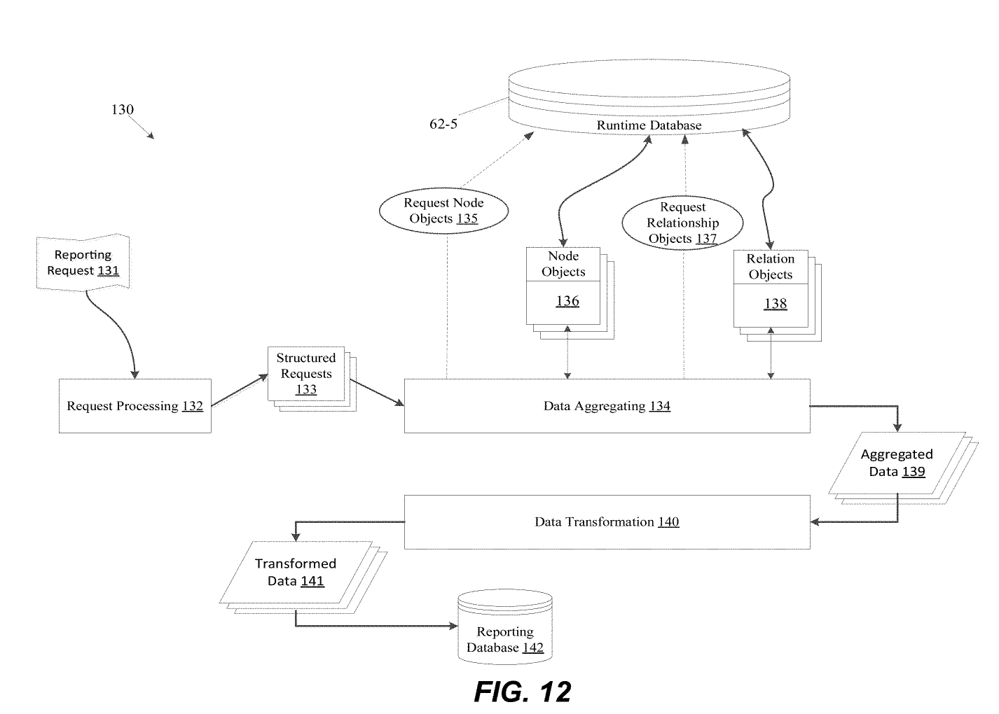

FIG. 12 illustrates a process flow diagram of a runtime environment 60 (FIG. 6) processing a reporting operation 130, according to an embodiment of the disclosure. Request processing 132 receives a reporting request 131 and generates one or more structured requests 133. In one embodiment, the structured requests 133 may include a tree-structure identifier (e.g., corresponding to tree-structure 1), and one or more parameters for search queries to be run at runtime database 62-5. Data aggregating 134 receives the structured requests 133, and generates one or more node object requests 135 and relationship object requests 137 responsive to the structured requests 133. Data aggregating 134 generates aggregated data 139 responsive to one or more received node objects 136, relationship objects 138, and structured requests 133. During data transformation 140, the aggregated data 139 is transformed into a desired format generating transformed data 141. In one embodiment, the data format may be a parameter included with the aggregated data 139. In another embodiment, data transformation 140 may be associated with a specific data format. The transformed data 141 is loaded into reporting database 142. One or more reports may be run against the reporting database 142 and published or otherwise made available.

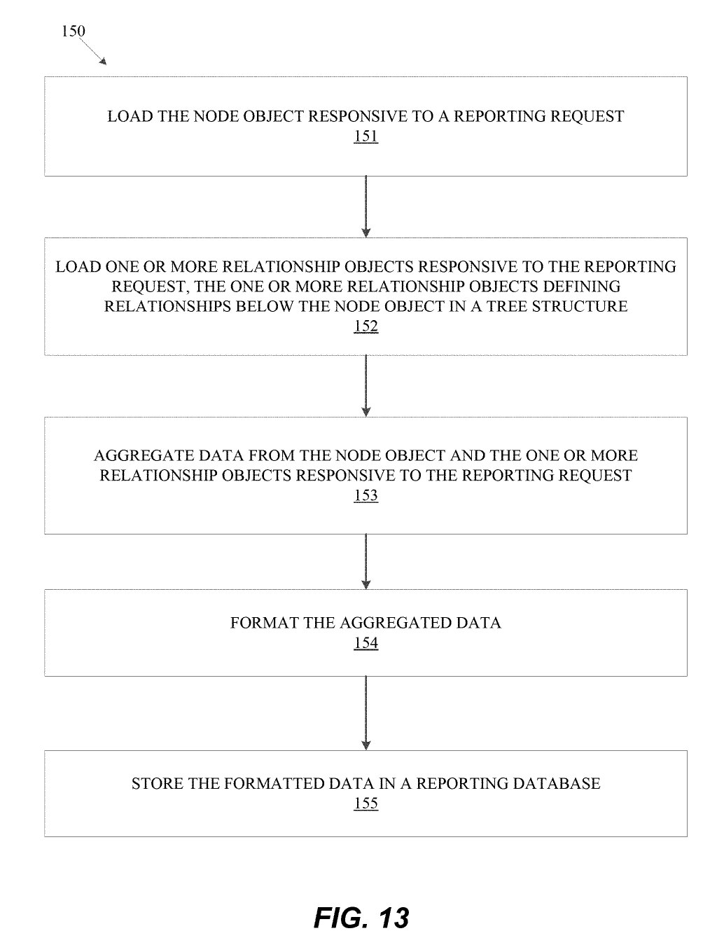

FIG. 13 illustrates a reporting operation performed by the runtime engine 62 and the database reporting module 62-6 for a node object in the tree-structure 1, according to an embodiment of the disclosure. A node object is loaded responsive to a reporting request, in operation 151. In one embodiment, the reporting request is a structured request 133. One or more relationship objects are loaded responsive to the reporting request in operation 152. The one or more relationship objects define relationships between the node object and one or more child objects in the tree-structure 1. Data is aggregated from the node object and the one or more relationship objects in operation 153. The aggregated data is formatted in operation 154, and the formatted data is stored in a reporting database in operation 155.

The features of the various embodiments described herein are not mutually exclusive and can exist in various combinations and permutations, even if such combinations or permutations are not expressly described herein, without departing from the scope of the disclosure. In fact, variations, modifications, and other implementations of what is described herein will occur to one of ordinary skill in the art without departing from the scope of the disclosure. As such, the invention is not to be defined only by the preceding illustrative description, but only by the claims which follow, and legal equivalents thereof.

1. A computer-implemented method of updating a node object in a tree-structure, the method comprising:
updating at least one attribute of the node object responsive to an attribute associated with a sub-tree of the tree-structure and one or more attribute rules, and
wherein the tree-structure comprises the node object, at least one child-node object to the node object, and at least one relationship object defining a parent-child relationship among the node object and the at least one child-node object, and
wherein the at least one relationship object includes at least some attributes of the sub-tree of the tree-structure.

2. The computer-implemented method of claim 1, further comprising:
requesting a plurality of node objects at a same level in the tree-structure, wherein the plurality of node objects are at a level below a level of the node object to be updated; and
updating one or more of the plurality of node objects.

3. The computer-implemented method of claim 2, further comprising:
updating one or more relationship objects responsive to updating one or more of the plurality of node objects and one or more relationship rules.

4. The computer-implemented method of claim 3, wherein the at least one relationship object is one of the one or more relationship objects.

5. The computer-implemented method of claim 3, wherein the attribute of the sub-tree comprises one of a quality attribute, a characteristic attribute, and a partial computation attribute.

6. The computer-implemented method of claim 3, wherein updating one or more relationship objects comprises:
determining at least one relationship rule associated with the one or more relationship objects;
computing a value representative of a contribution to a dependent attribute of the node object; and
updating at least one attribute of the one or more relationship objects with the computer value.

7. The computer-implemented method of claim 2, wherein requesting the plurality of node objects comprises a set operation.

8. The computer-implemented method of claim 2, wherein the updating one or more of the plurality of node objects comprises updating the plurality of node objects in parallel.

9. A system, comprising:
a database store having stored thereon a database, wherein the database comprises records and relationship records that define one or more hierarchical relationships among the records; and
a computer system operative to be executed as a database engine system responsive to requests received related to the database, the database engine system including:
a record update module configured to update at least one record of the database responsive to changes to one or more other records of the database, wherein the one or more other records are below the updated record in a first hierarchy of the database; and
a relationship record update module configured to update at least one relationship record responsive to changes to records of the first hierarchy of the database.

10. The system of claim 9, wherein the database is a row-oriented database.

11. The system of claim 9, wherein the database is a columnar database.

12. The system of claim 11, further comprising an application server system configured to generate at least some of the requests received relative to the database.

13. The system of claim 12, wherein the application server system comprises an online transaction processing system.

14. The system of claim 9 wherein the hierarchical relationship is representative of a tree-structure.

15. A system, comprising:
a database store having stored thereon a database, wherein the database comprises records and relationship records that define one or more hierarchical relationships among the records; and
a computer system operative to be executed as a database engine system responsive to requests received related to the database, the database engine system including:
a record update module configured to retrieve and update, in parallel, a first group of records of the database responsive to a first update request, wherein the first group of records are associated with a lowest level of a hierarchy of the database; and
a relationship record update module configured to retrieve and update, in parallel, a first group of relationship records responsive to updating the first group of records, wherein the first group of relationship records define a hierarchical relationship between the first group of records and a second group of records, wherein the second group of records are associated with a higher level of the hierarchy of the database than the first group of records.
